(19) United States
(12) Patent Application Publication
(10) Pub. No.: US 2016/0304066 A1
(43) Pub. Date: Oct. 20, 2016

(54) LEVELING JACK WITH DIRECT ACTUATION

(71) Applicant: LIPPERT COMPONENTS, INC., Elkhart, IN (US)

(72) Inventor: Michael Warren NEBEL, Smith Center, KS (US)

(21) Appl. No.: 15/081,106

(22) Filed: Mar. 25, 2016

Related U.S. Application Data
(60) Provisional application No. 62/207,584, filed on Aug. 20, 2015.
(60) Provisional application No. 62/139,413, filed on Mar. 27, 2015.

(51) Int. Cl. B60S 9/06; B66F 3/08; B60S 9/10; B66F 3/24

(52) U.S. Cl. CPC B60S 9/06; B66F 3/24; B66F 3/247; B66F 3/08; B60S 9/10; B66F 2700/04; B66F 2700/05

(57) ABSTRACT

A leveling and stabilizing jack 10 includes an intermediate member joining first and second lifting sections. Each lifting section includes a cross beam, a leg, a brace, a foot, a motor and a drive screw. The motor powers the drive screw, which is operably associated with the leg, to cause the leg to extend away from or retract toward the cross beam depending on the motor's direction of rotation. A motor control can control the motor of each of the lifting sections independently in a manner that results in leveling of the jack when deployed.

### CROSS-REFERENCE TO RELATED APPLICATIONS

This application claims benefit of U.S. Provisional Patent Application No. 62/139,413, filed Mar. 27, 2015, and U.S. Provisional Patent Application No. 62/207,584, filed Aug. 20, 2015, and incorporates by reference the disclosures thereof in their entireties.

### BACKGROUND AND SUMMARY OF THE DISCLOSURE

The present disclosure is directed to jacks, for example, jacks for leveling and stabilizing recreational vehicles and the like when parked.

### BRIEF DESCRIPTION OF THE DRAWINGS

FIG. 1 is a perspective view of a jack according to the present disclosure in a deployed condition;

FIG. 2 is a side elevation view of the jack of FIG. 1;

FIG. 3 is a top plan view of the jack of FIG. 1;

FIG. 4 is a perspective view of a jack according to the present disclosure in a retracted condition;

FIG. 5 is a side elevation view of the jack of FIG. 4;

FIG. 6 is a top plan view of the jack of FIG. 4;

FIG. 7 is a bottom perspective view of the jack of FIG. 1;

FIG. 8 is a perspective view showing a detail of the jack of FIG. 1;

FIG. 9 is detail perspective view showing a detail of the jack of FIG. 1;

FIG. 10 is detail perspective view showing a detail of the jack of FIG. 1;

FIG. 11 is side elevation view of a lifting section of the jack of FIG. 1;

FIG. 12 is a top plan view of the lifting section of FIG. 11;

FIG. 13 is a perspective view of the lifting section of FIG. 11;

FIG. 14 is an end elevation view of the lifting section of FIG. 11;

FIG. 15 is a cross section of a portion of the lifting section of FIG. 11;

FIG. 16 is a cross section of a portion of the lifting section of FIG. 11;

FIG. 17 is a cross section of a portion of the lifting section of FIG. 11;

FIG. 18 is a cross section of a portion of the lifting section of FIG. 11;

FIG. 19 is a cross section of a portion of the lifting section of FIG. 11;

FIG. 20 is a cross section of a portion of the lifting section of FIG. 11;

FIG. 21 is a cross section of a portion of the lifting section of FIG. 11;

FIGS. 22A-22D are views of a guide block for a drive screw of the jack of FIG. 1;

FIG. 23 is a perspective view of another jack according to the present disclosure;

FIG. 24 is a top plan view of the jack of FIG. 23.

FIG. 25 is a perspective view of a mounting plate of the jack of FIG. 23 and mating bracket attached to a cross member of a frame of a vehicle; and

FIG. 26 is a side elevation view of a mounting plate of the jack of FIG. 23 and mating bracket attached to a cross member of a frame of a vehicle

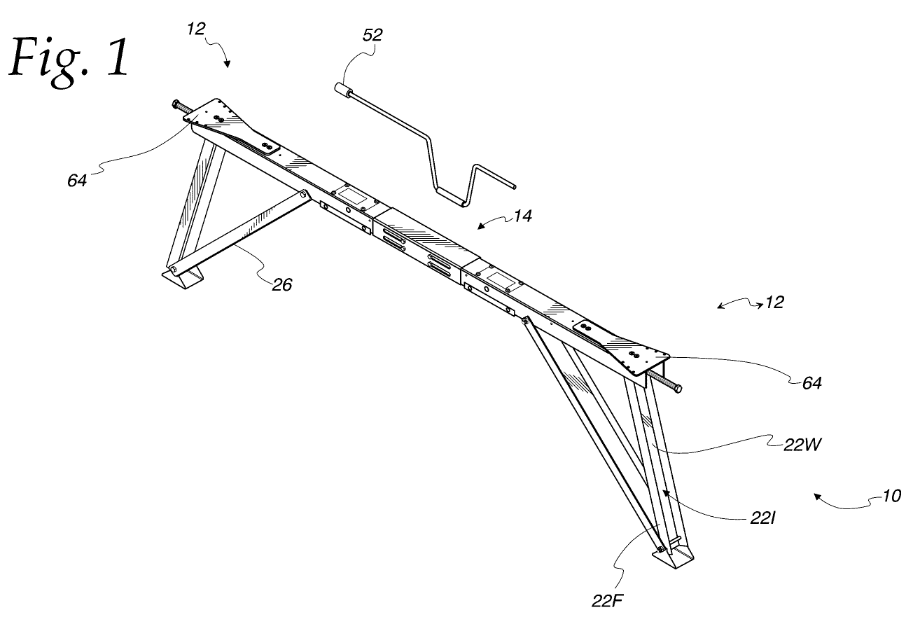

### DETAILED DESCRIPTION OF THE DRAWINGS

References herein to direction and orientation, for example, upper, lower, top, bottom, and the like, are intended to describe relative orientation and are not to be construed as absolute unless context clearly dictates otherwise.

The drawings illustrate embodiments of a leveling and stabilizing jack 10 including a first lifting (or end) section 12 and optionally including a second lifting section 12 and an intermediate member 14 connecting the first and second lifting sections. The first and second lifting sections 12 may be identical to or minor images of each other. As such, they will be discussed interchangeably.

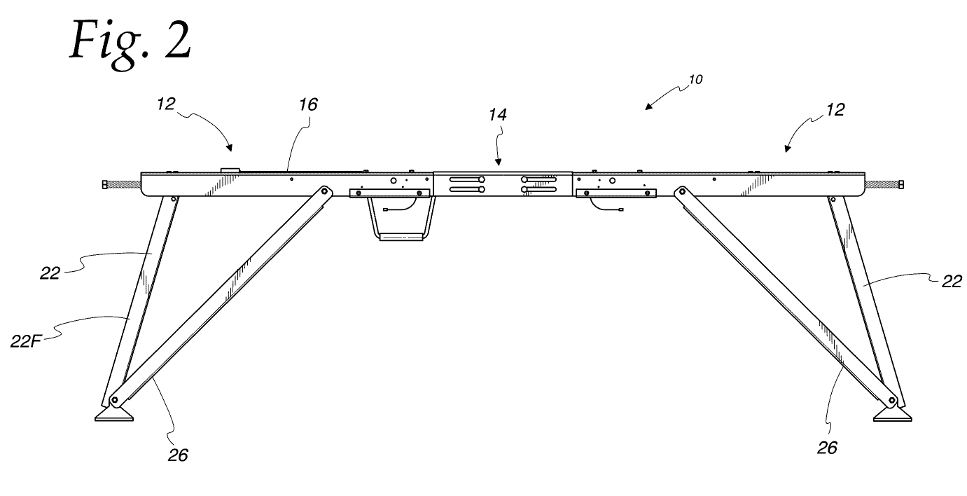

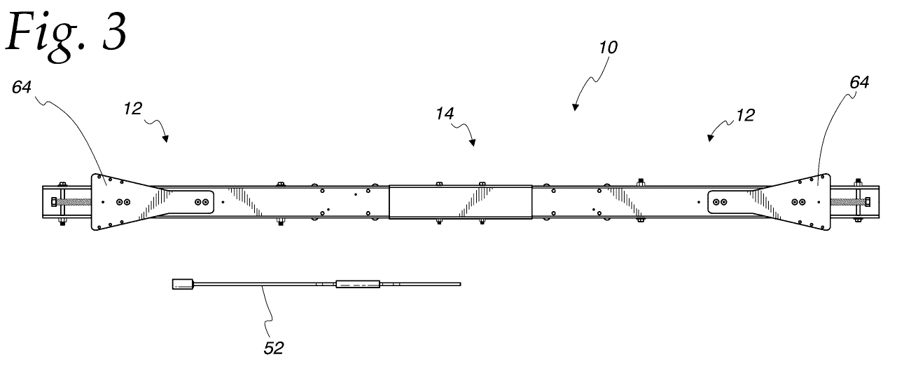

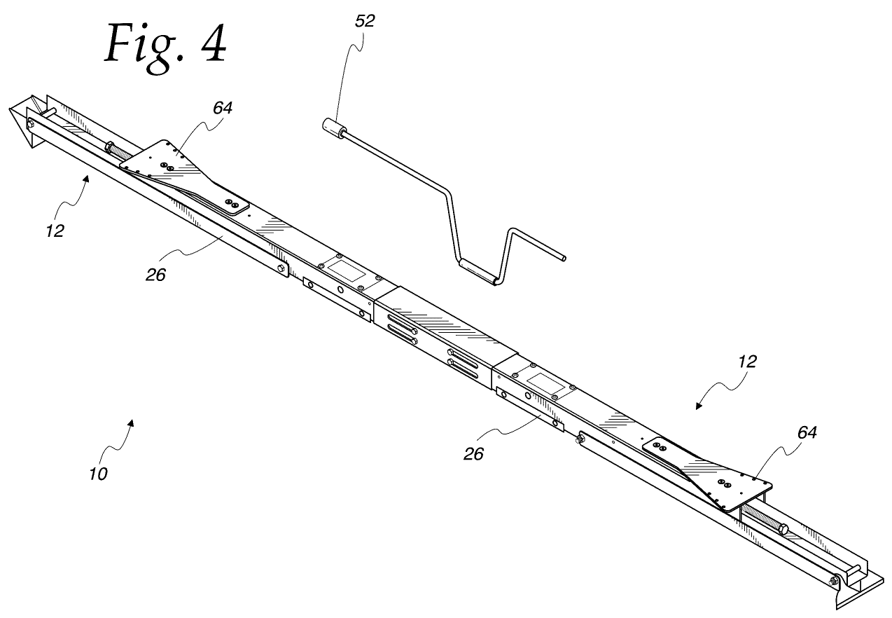

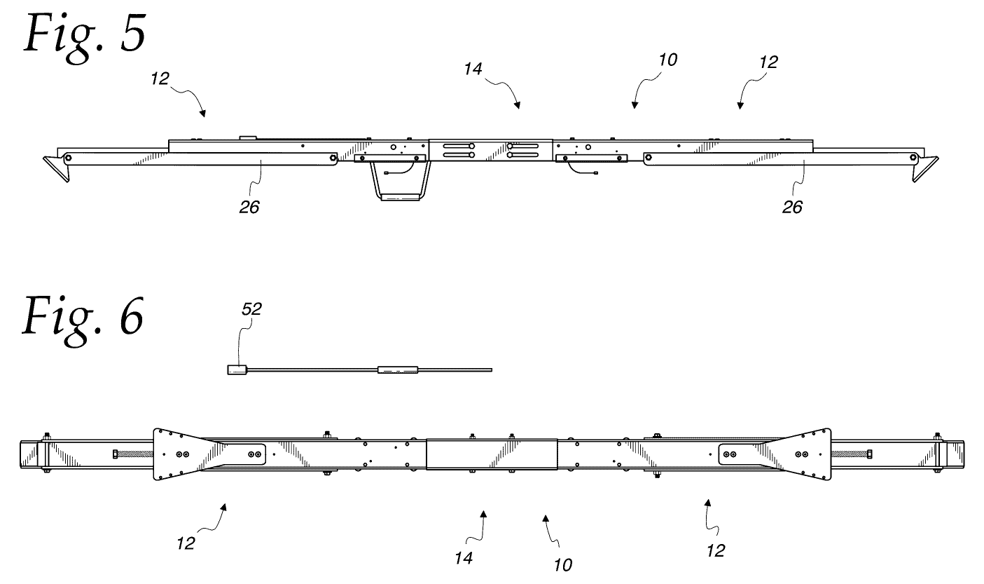

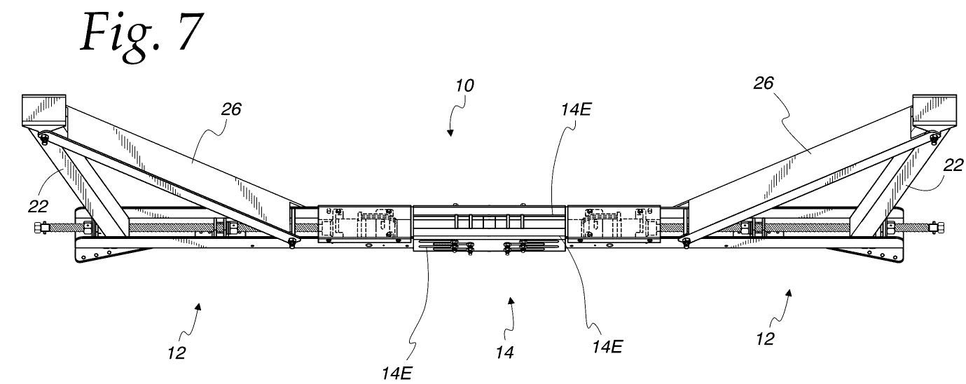

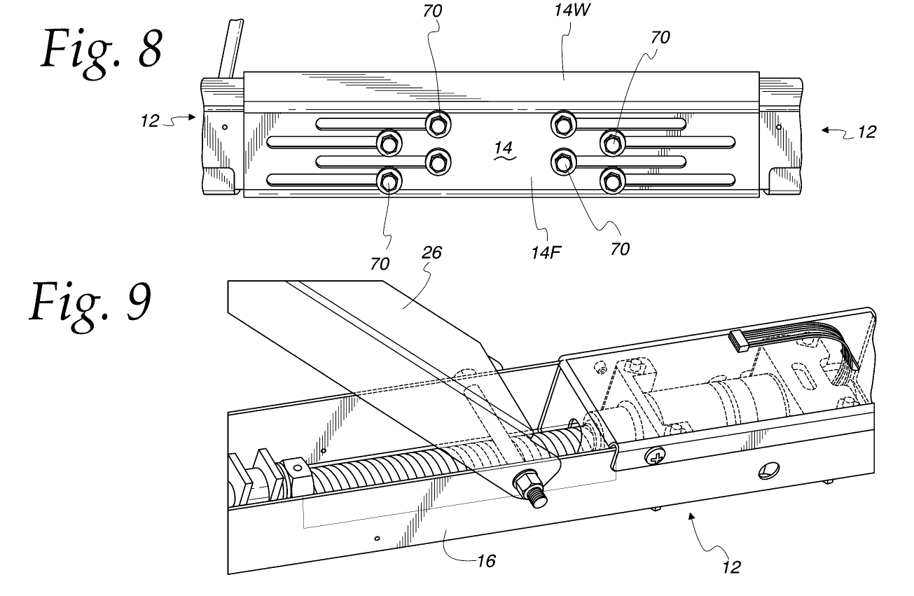

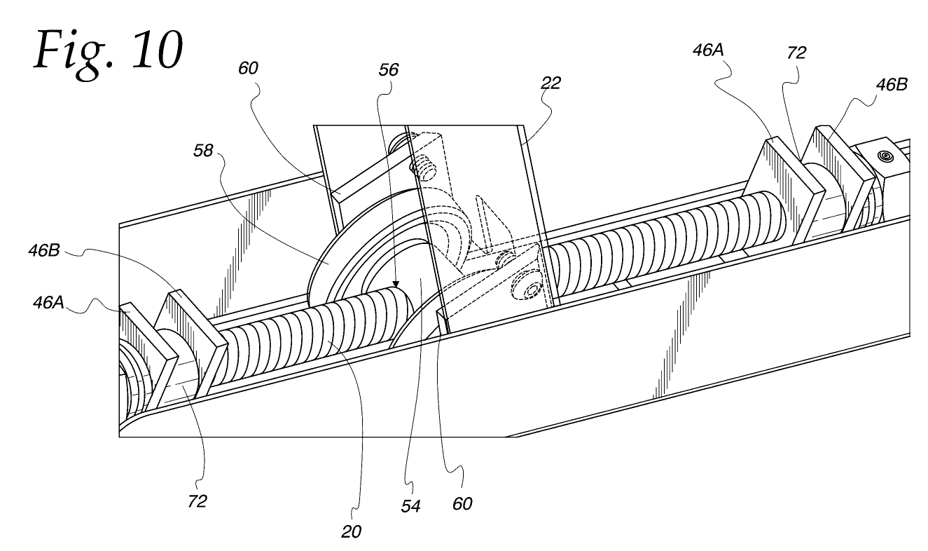

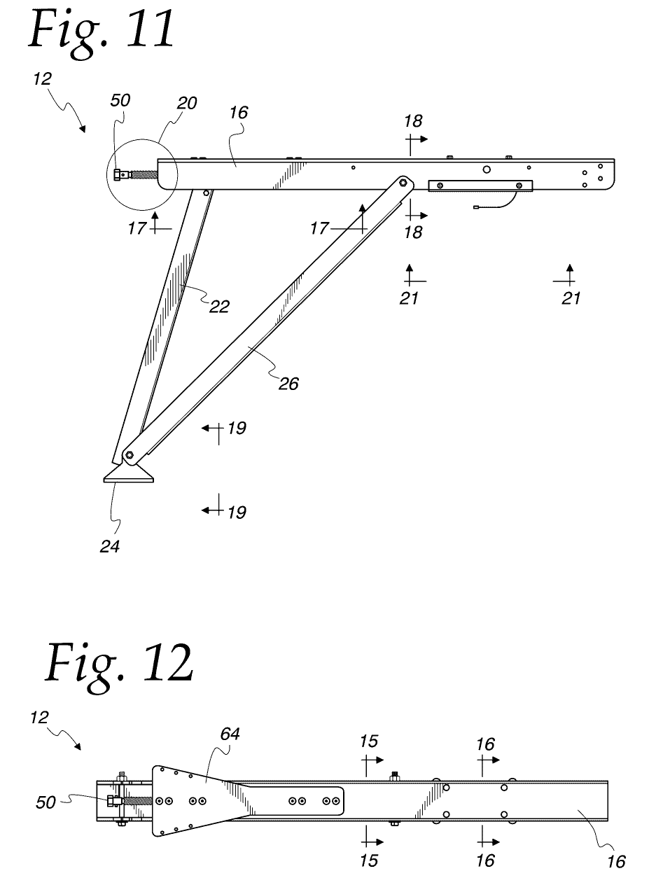

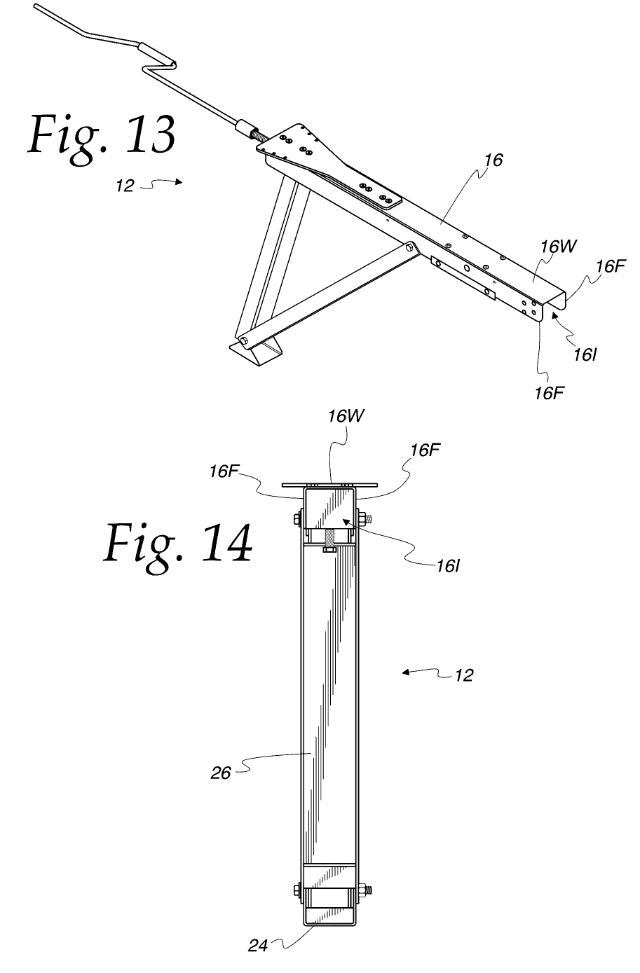

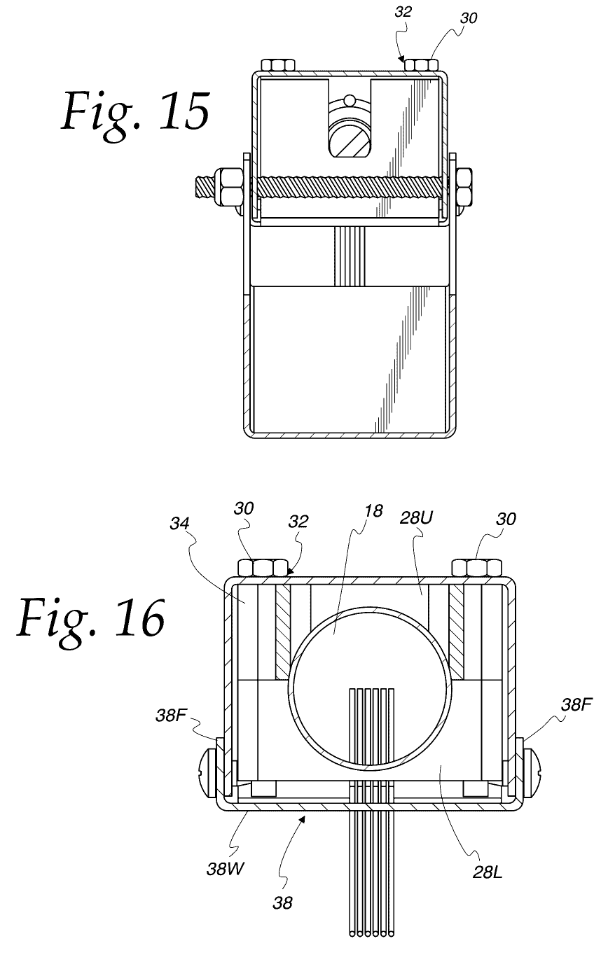

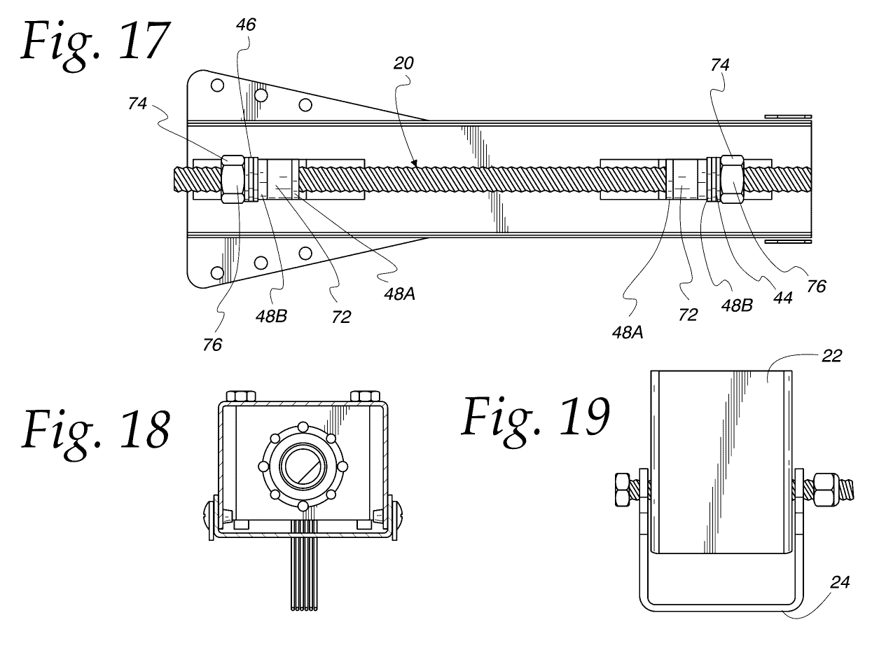

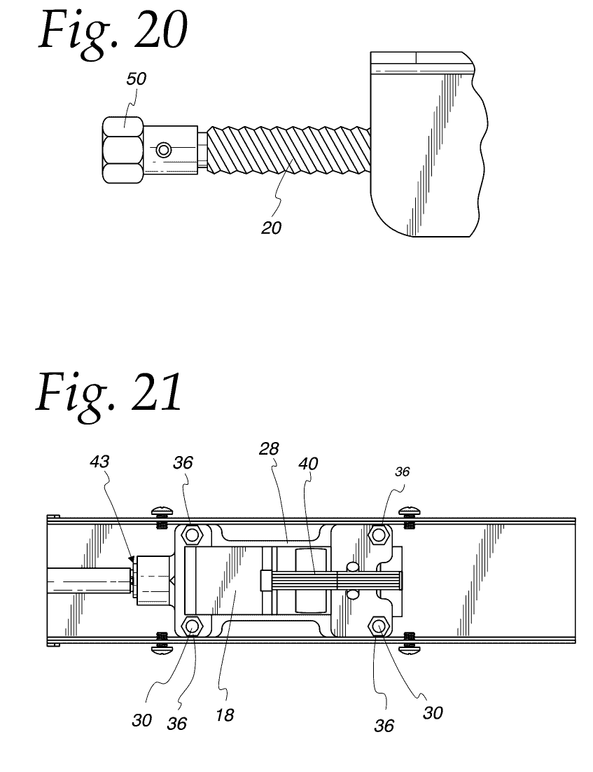

Each lifting section 12 includes a cross beam 16, a motor 18, a drive screw 20 rotationally engaged with the motor, an extendable and retractable leg 22 operably associated with the drive screw, a foot 24 pivotally connected to a second end of the leg, and a brace (or support arm) 26 having a first end pivotally engaged with the cross beam and a second end pivotally engaged with the second end of the leg and the foot. As will be discussed further below, operation of the drive screw 20 in a first direction of rotation causes the second end of the leg 22 and the foot 24 to extend away from the cross beam 16 to a first (or extended or deployed) position, and operation of the drive screw 20 in a second direction of rotation causes the second end of the leg 22 and the foot 24 to retract toward the cross beam 16 to a second (or retracted) position. Also, operation of the drive screw 20 in a first direction causes both the leg 22 and the brace 26 to rotate through respective arcs in a first rotational direction (for example, clockwise, as viewed from the side of the left one of the two lifting sections 12 shown in FIG. 2), and operation of the drive screw in a second direction causes both the leg and the brace to rotate through respective arcs in a second rotational direction (for example, counterclockwise, as viewed from the same side of the lifting section). A mounting plate 64 may be attached to the cross beam 16 and configured for further attachment to a vehicle (not shown) or other structure to be leveled and/or stabilized by the jack.

The cross beam 16 is shown as an elongated, u-shaped channel having a web 16W and a pair of generally parallel flanges 16F. The flanges 16F extend in the same direction from opposite edges of the web. The web 16W and flanges 16F cooperate to define an interior region 16I of the cross beam 16.

The motor 18, including an armature or shaft 40, is disposed within a motor block 28 in fixed relation thereto. The motor block 28 may have an upper portion 28U and a lower portion 28L, and the motor 18 may be sandwiched between or encompassed by the upper and lower portions of the motor block.

The motor block 28 is attached to the cross beam 16 in fixed relation thereto. The motor block 28 may be partially or fully contained within the interior region of the cross beam 16. The motor block 28 may be attached to the cross beam 16 using mechanical fasteners, adhesives, or by welding. In the illustrated embodiment, the motor block 28 is attached to the cross beam 16 by motor block mounting bolts 30 extending through respective apertures 32 in the web 16W of the cross beam and apertures 34 in the upper portion 28U and lower portion 28L of the motor block, and captured thereto by nuts 36. In other embodiments, other forms and/or arrangements of threaded or unthreaded mechanical fasteners (for example, rivets) may be used to attached the motor block 28 to the cross beam 16. In further embodiments, the motor 18 may be attached directly or through brackets to the cross beam 16 in other ways, and the motor block 28 may be omitted.

A motor cover 38 may be provided to at least partially enclose the motor 18 and/or motor block 28. The motor cover 38 is shown as a generally u-shaped channel having a web 38W and a pair of parallel flanges 38F extending in the same direction from the web. The motor cover 38 may be attached to the cross beam 16, for example, using screws 36 or other fasteners extending through respective apertures in one or both of the motor cover flanges 38F and one or both of the flanges 16F of the cross beam 16.

The drive screw 20 may be, for example, an elongated, cylindrical shaft having drive threads, for example, Acme threads.

The drive screw 20 may be supported in rotational engagement by a first thrust bearing 44 relatively near the motor 18, and a second thrust bearing 46 relatively far from the motor 18. Each of the thrust bearings 44, 46 may bear against a respective drive screw guide 48. Each drive screw guide 48 may be attached to the cross beam 16, for example, to the web 16W of the cross beam. The drive screw 20, thrust bearings 44, 46, and drive screw guides 48 may be fully contained within the interior region 161 of the cross beam 16.

Each of the drive screw guides 48 is shown as a pair of metal angles 48A, 48B, each having a first leg or flange attached to the inner surface of the web 16W cross beam 16 and a second leg or flange extending generally perpendicularly from the web 16W. The first legs of the angles are shown as extending in opposite directions. The angles may be attached to the web by any suitable means. For example, the first legs of the angles 48A, 48B may be attached to the web 16W of the cross beam 16, for example, using mechanical fasteners or by welding. The second legs of the angles 48A, 48B may serve to support the drive screw 20 in rotational engagement. More specifically, the second legs of the angles 48A, 48B may include respective apertures though which the drive screw 20 may be inserted and within which the drive screw may rotate. A spacer 72 may be disposed and engaged between the second legs of the angles 48A, 48B of each drive screw guide 48. The spacer 72 may serve to preclude substantial deformation of the second legs of the angles 48A, 48B, as will become apparent from the discussion of the operation of the jack 10 below. Substantial deformation of the second legs of the angles 48A, 48B could result in burring of the drive screw 20 during operation, as will become apparent from the discussion of the operation of the jack 10 below.

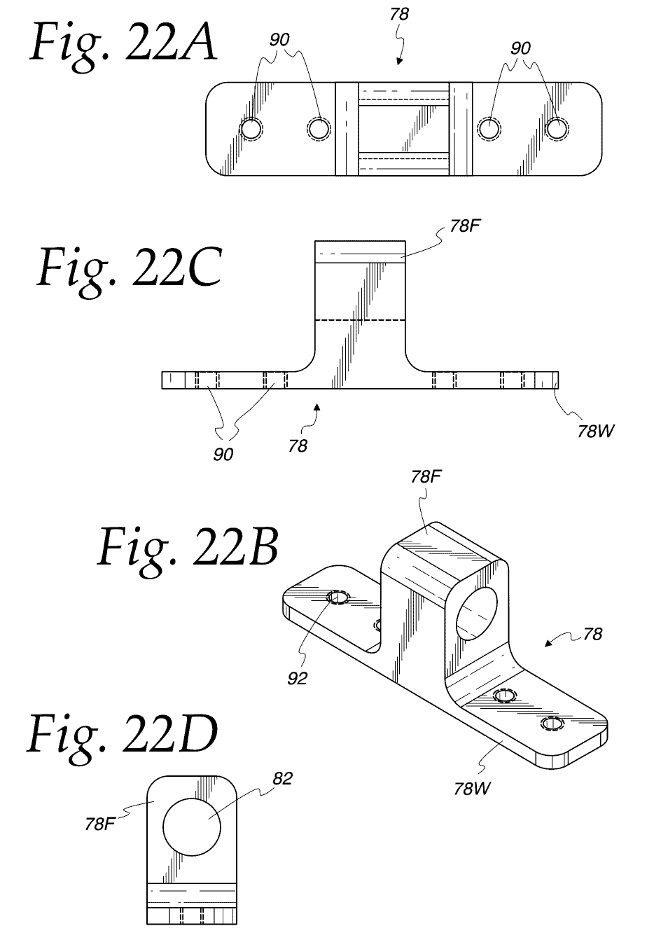

The drive screw guides 48 may be configured in other ways, as well. For example, the respective pairs of angles 48A, 48B and the spacer 72 may be replaced with a guide block 78, as shown in FIGS. 22A-22D. The guide block 78 is shown as including a web portion 78W configured for attachment to the web 16W of the cross beam 16. The web 78W defines a plurality of apertures 90 configured to receive mechanical fasteners for attaching the guide block 78 to the cross beam 16. The apertures 90 could be omitted and guide block 78 could be attached to the cross beam 16 by welding, adhesive bonding, or other means. The guide block 78 also include a flange 78F extending generally perpendicularly from the web 78W. The flange 78F defines an aperture 82 configured to receive the drive screw 20 in rotational engagement. As such, the guide block 78 may serve to support the drive screw 20 in rotational engagement. The guide block 78 may be sufficiently robust to receive and withstand without substantial deformation the thrust load imparted by the respective thrust bearing 44, 46 during operation of the jack 10, as will become apparent from the discussion below.

An adjusting nut 74 may be provided in connection with each thrust bearing 44, 46, with the respective thrust bearing being located between the respective bearing support and respective adjusting nut. Each adjusting nut 74 may have an internal thread complementary to the thread of the drive screw 20. The thrust bearings 44, 46 and/or drive screw 20 may be preloaded by torqueing each adjusting nut 74 against the respective thrust bearing. A set screw 76 may be provided in connection with each adjusting nut 74 to maintain the adjusting nut in a desired position with the respect to the drive screw. The set screw 76 may thread into a corresponding aperture extending radially through the adjusting nut 74, for example, from one of its flats to its interior.

A first end of the drive screw 20 may be connected to the motor shaft 40 by a motor coupler 42. A second end of the drive screw 20 may include an optional fitting 50 configured for connection to a mating tool that could be used to operate the jack in the event the motor 18 or its power supply fails. For example, the fitting 50 could be a conventional hex head, and the mating tool could be a complementary socket attached to a speed wrench 50, power drill, or other tool. In an embodiment, the motor 18 could be omitted and the fitting 50 and mating tool could be the primary means for operating the jack.

A trunnion (or travel nut) 54 is captured on the drive screw 20 between the first and second thrust bearings 44, 46. The travel nut 54 may be a cylindrical shaft defining an aperture 56 diametrically there through. The aperture 56 may have an internal thread complementary to the thread of the drive screw 20. The travel nut 54 is rotationally and threadingly engaged with the drive screw 20.

Rollers 58 may be provided proximate opposite ends of the travel nut 54 and may be rotatably attached to the travel nut. For example, the travel nut 54 may serve as an axle for the rollers 58. The rollers 58 may be in selective or constant engagement with the inner surface (the surface facing the interior 16I) of the web 16W of the cross beam 16. Such engagement may be rolling engagement. The selective or constant engagement of the rollers 58 with the inner surface of the web 16W preclude or substantially inhibit rotation of the travel nut 54 with respect to the cross beam 16, for example, while the drive nut is rotating. In an embodiment, the rollers 58 could be omitted and the travel nut 54 could be in sliding engagement with the cross beam 16.

The leg 22 is shown as an elongated, u-shaped channel having a web 22W and a pair of parallel flanges 22F extending in the same direction from opposite edges of the web.

The travel nut 54 is operably associated with the first end of the leg 22. A first bearing block 60 may be connected to a first flange 22F of the leg 22, and a second bearing block 60 may be connected to a second flange 22F of the leg 22, opposite the first bearing block. Each bearing block 60 may define an aperture (not shown) configured to receive a respective end of the travel nut 54 in rotational or non-rotational or fixed engagement therewith. For example, one or both ends of the travel nut 54 may be keyed to the respective bearing block 60. The ends of the travel nut 54 may be inserted into the apertures (not shown) of the bearing blocks 60 and the travel nut/bearing block subassembly inserted into the interior region 221 of the leg 22 and the bearing blocks 60 secured to the flanges 22F of the leg 22.

Alternatively, the bearing blocks may be omitted, and each of the first and second flanges 22F of the leg 22 may define an aperture configured to receive a respective end of the travel nut 54 in rotational or non-rotational engagement therewith. For example, the ends of the travel nut 54 may extend through corresponding apertures (not shown) proximate the first end of the leg 22. The ends of the travel nut 54 may be threaded to receive corresponding nuts (not shown). The nuts may be provided with a thread locker such as LOCTITE® to allow the nuts to become secured to the travel nut without tightening them against the flanges of the leg 22.

As set forth above, the second end of the leg 22 is pivotally connected to the second end of each of the braces 26, and the first end of each of the braces is pivotally connected to the cross beam 16. As such, as the first end of the leg 22 moves away from the second thrust bearing 46 (and corresponding drive screw guide 48) and toward the first thrust bearing 44 (and corresponding drive screw guide 48), the second end of the leg moves toward the cross beam 16 to a retracted position. Conversely, as the first end of the leg 22 moves away from the first thrust bearing 44 (and corresponding drive screw guide 48) and toward the second thrust bearing 46 (and corresponding drive screw guide 48), the second end of the leg moves away from the cross beam 16 to an extended (or deployed) position. As the second end of the leg 22 approaches the fully deployed positon, the second end of the leg 22 and the foot 24 attached thereto travel through a path that is substantially perpendicular to the cross beam 16, rather than substantially arcuate.

A first of the two lifting sections 12 has been described above. The other of the lifting sections 12 may be identical to or the mirror image of the first lifting section and need not be discussed in further detail.

As set forth at the outset, the first of the lifting sections 12 may be connected to the second of the lifting sections 12 by the intermediate member 14. The intermediate member 14 may be an elongated C-shaped channel having a web 14W, a pair of generally parallel flanges 14F extending from the same side of the web 14W, and an ear 14E extending from an end of each flange 14F opposite the web 14W toward a corresponding end of the other flange. As such, the ears 14E may be generally perpendicular to the flanges 14F and generally coplanar with each other. The ears 14E could be omitted. Where provided, the ears 14E may cooperate with the web 14W to provide structural integrity to the connection of the intermediate member 14 to the lifting sections 12.

In the illustrated embodiment, the ends of the cross beams 16 of each lifting section 12 facing each other define a plurality of staggered round apertures 34. The intermediate member 14 has first and second ends, each of which defines a plurality of longitudinally-staggered corresponding slotted apertures 68. The lifting sections 12 and intermediate member 14 may be assembled with the corresponding apertures 34, 68 coaxially aligned so that fasteners 70 may be received therethrough. The slotted apertures 68 in the intermediate member 14 allow for limited adjustment of the overall length of the jack 10 prior to tightening or otherwise securing the fasteners 70.

A motor controller (not shown) may be provided for independently controlling the motor 18 of each of the lifting sections 12.

In operation, the leg 22 of each lifting section may be deployed by energizing the corresponding motor 18 to rotate in the first direction, causing the drive screw 20 connected to the motor shaft or armature to rotate in the same direction. The selective or constant engagement of the rollers 58 attached to the travel nut 54 preclude the travel nut from rotating significantly with respect to the drive screw 20. As such, the rotation of the drive screw 20 causes the travel nut 54 to travel away from the motor 18. Because the travel nut 54 is attached to the first end of the leg 22, the first end of the leg travels with the travel nut away from the motor 18. Because the second end of the leg 22 is pivotally connected to the second end of the brace 26, and because the first end of the brace is pivotally connected to the cross beam 16, this travel of the first end of the leg 22 causes the second end of the leg, the second end of the brace, and the foot to travel away from the cross beam 16. With the jack 10 installed on a bottom portion of a recreational vehicle or other structure, the foot 24 moves toward and into contact with the ground underneath the vehicle. During the latter part of the travel, the motion of the foot may be substantially, though not absolutely, perpendicular to the cross beam 16. When fully deployed, the leg 22 may be substantially, though not necessarily absolutely, perpendicular to the cross beam 16, and the brace 26 may provide angular support to the second end of the leg.

The motor control may be configured to stop the motor based on travel limits, motor torque, and/or motor current. For example, one or more limit switches (not shown) could be provided in operable association with the travel nut 54 and configured to cause power to the motor to be interrupted when a predetermined travel limit of the travel nut 54 has been reached. In an embodiment, a current sensor (not shown) could monitor motor current and cause power to the motor 18 to be interrupted when the motor current reaches or exceeds a predetermined threshold. In an embodiment, a torque sensor (not shown) could monitor torque output of the motor 18 or the drive screw 20 and cause power to the motor to be interrupted when a predetermined torque is reached or exceeded.

Because the motor control may be configured to control the motor 18 of each of the lifting sections 12 independently, the leg 22 and foot 24 of one of the lifting sections may be deployed to a greater or lesser extent than those of the other of the lifting sections 12.

The leg 22 of each lifting section may be retracted by energizing the corresponding motor 18 to rotate in the second direction, causing the drive screw 20 connected to the motor shaft or armature to rotate in the same direction. The selective or constant engagement of the rollers 58 attached to the travel nut 54 preclude the travel nut from rotating significantly with respect to the drive screw 20. As such, the rotation of the drive screw 20 causes the travel nut 54 to travel toward the motor 18. Because the travel nut 54 is attached to the first end of the leg 22, the first end of the leg travels with the travel nut away toward the motor 18. Because the second end of the leg 22 is pivotally connected to the second end of the brace 26, and because the first end of the brace is pivotally connected to the cross beam 16, this travel of the first end of the leg 22 causes the second end of the leg, the second end of the brace, and the foot to travel toward the cross beam 16.

The motor control may be configured to stop the motor based on travel limits, motor torque, and/or motor current. For example, one or more limit switches (not shown) could be provided in operable association with the travel nut 54 and configured to cause power to the motor to be interrupted when a predetermined travel limit of the travel nut 54 has been reached. In an embodiment, a current sensor (not shown) could monitor motor current and cause power to the motor 18 to be interrupted when the motor current reaches or exceeds a predetermined threshold. In an embodiment, a torque sensor (not shown) could monitor torque output of the motor 18 or the drive screw 20 and cause power to the motor to be interrupted when a predetermined torque is reached or exceeded. In an embodiment, the motor control could be configured to stop the motor 18 when the leg 22 and foot are fully retracted. In this state, at least a portion of the leg 22 may nest within the cross beam 16, and at least a portion of the cross beam may nest within the brace 26. Alternatively, the cross beam 16, leg 22, and brace 26 could be configured such that at least portions of both the leg and brace may nest within the cross beam in the foregoing retracted state.

In operation, the drive screw guides 48 (including the first and second angles 48A, 48B and intermediate spacer 72) or guide blocks 78 may limit the linear travel of the travel nut 54. As such, the travel nut 54 may bear against and impart a thrust load against the drive screw guides 48 or guide blocks 78. The drive screw guides 48 or guide blocks 78 may transmit this load or a portion thereof to the respective thrust bearings 44, 46.

In an embodiment, a level sensor (not shown) may be provided and operably associated with the motor control. In such an embodiment, the motor control could independently control operation of the motors 18 of the respective lifting sections 12 in a manner that results in the jack 10, including the intermediate member 14 and the cross beams 16, and/or structure to which it may be attached being substantially level when the power to the respective motors is interrupted. Put another way, the jack may be operated so that the legs 22 of the respective lifting sections 12 may extend to different extents so as to generally level the jack 10 and the structure to which the jack may be attached.

In an embodiment, the jack may have only a single lifting section 12. In such an embodiment, the other lifting section 12 would be omitted and the intermediate member 14 could be omitted, as well. Also in such an embodiment, a second mounting plate, for example, a second mounting plate 64 could be attached to another portion, for example, the opposite end, of the cross beam 16 (or to a portion of the intermediate member 14, if maintained). Numerous ones of such jacks having a single lifting section 12 could be attached to various portions of a structure to be supported, leveled, and/or stabilized thereby. For example, a first such jack could be installed proximate a first corner of a vehicle, a second such jack could be installed proximate a second corner of the vehicle, and so on. The individual jacks could interface with a motor controller and/or level sensor, as discussed above.

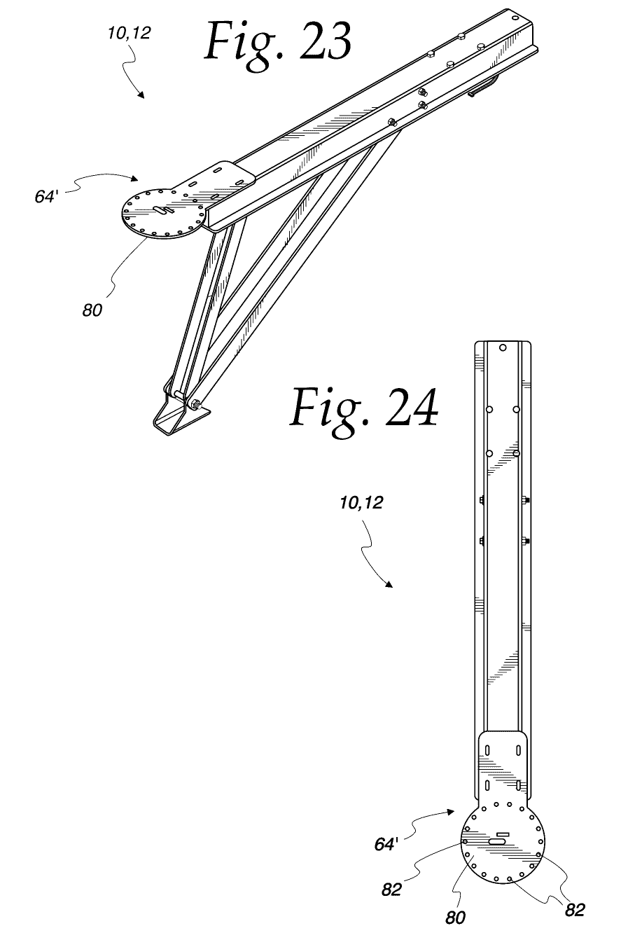

In another such embodiment, the mounting plate 64 described above could be replaced with a mounting plate 64′ having a circular portion 80 configured for attachment to a vehicle or other structure. One example of such a mounting plate 64′ is shown in FIGS. 23-26. The circular portion 80 of the mounting plate 64′ could be provided with a plurality of apertures 82 about its periphery in a circular or other non-linear arrangement. In an embodiment, the apertures 82 could be configured so that at least some of them may be selectively aligned with corresponding apertures on the vehicle or other structure. For example, corresponding apertures could be provided on a frame member of the vehicle or other structure. Mechanical fasteners could be inserted through respective apertures to secure the mounting plate 64′ to the vehicle or structure. A second mounting plate 64 or 64′ could be provided at or near the other end of the cross beam 16. The mounting plate(s) 64, 64′ could be attached to the cross beam 16 by any suitable means, for example, welding or using mechanical fasteners.

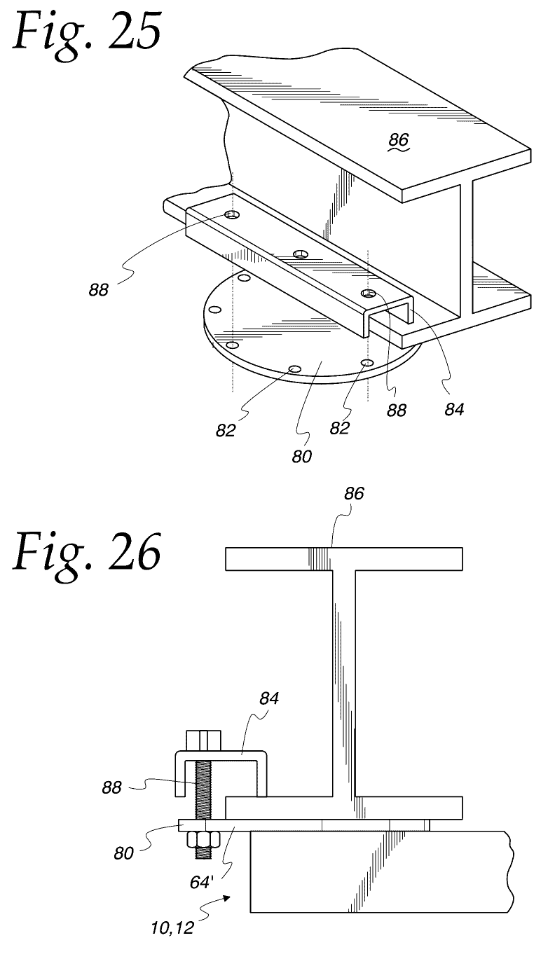

In an embodiment, the mounting plate 64′ could be attached to a portion of the vehicle or structure using a bracket 84, for example, as shown in FIGS. 25 and 26. The bracket 84 is shown as a length of channel having a web and a pair of parallel flanges extending from respective sides of the web. The web may define one or more apertures 88. One of the flanges of the bracket 84 and a surface of the mounting plate 64′ may cooperate to sandwich or otherwise capture there between a portion of a vehicle or structure, for example, a flange of an I-beam 86 of a frame of a vehicle to which the jack 10 is to be attached. One or more fasteners, for example, threaded fasteners 88 or rivets, may be inserted through corresponding apertures 82 in the mounting plate 64′ and apertures 88 in the bracket 84 and tensioned to secure the mounting plate 64′ to the structure.

Embodiments of a jack 10 including two lifting sections 12 typically would be attached to an RV or other structure with the cross beams 16 generally parallel to a width or length of the structure (although it could be attached in other orientations, as well). Embodiments of a jack 10 including only a single lifting section 12 may be more readily attached to the structure in other orientations. For example, a jack 10 including only a single lifting section may be more readily attached to an RV near a corner thereof and oriented at an angle (for example, 45 degrees) to the length and width of the vehicle. So oriented, the jack could provide both lateral and longitudinal support for the RV. The configuration of the mounting plate 64′ may provide more installation options than the mounting plate 64 in such an application. More specifically, the arrangement of apertures 82 in the circular portion 80 of the mounting plate 64′ allows the mounting plate 64′ to be attached to the RV or other structure in numerous angular orientations with respect to the RV or other structure.

In an embodiment, the electric motor and drive screw could be replaced with another form of drive mechanism, for example, a hydraulic or pneumatic actuator connected to the travel nut and configured to displace the travel nut between endpoints similar to those described above.

The foregoing embodiments are illustrative and not limiting. The embodiments could be modified as may be desired, yet fall within the scope of the appended claims. For example, without limitation, features disclosed in connection with a given embodiment could be incorporated into another embodied to the extent possible.

1. A jack comprising:
a first lifting section, the first lifting section comprising:
a first cross beam;
a first trunnion engaged with the first cross beam and selectively displaceable in first and second displacement directions with respect to the first cross beam between a first position and a second position;
a first leg pivotally connected to the first trunnion; and
a first brace pivotally connected to the first leg and pivotally connected to the first cross beam;
wherein displacement of the first trunnion with respect to the first cross beam in the first displacement direction results in rotation of the first leg in a first angular direction with respect to the first cross beam and rotation of the first brace in the first angular direction with respect to the first cross beam, and
wherein displacement of the first trunnion with respect to the first cross beam in the second displacement direction results in rotation of the first leg in a second angular direction with respect to the first cross beam and rotation of the first brace in the second angular direction with respect to the first cross beam.

2. The jack of claim 1 further comprising a first drive mechanism operably engaged with the first trunnion, the first drive mechanism configured to selectively displace the first trunnion in the first and second displacement directions with respect to the first cross beam.

3. The jack of claim 2 wherein the first drive mechanism comprises a first drive screw threadingly engaged with the first trunnion such that rotation of the first drive screw in a first direction of rotation results in displacement of the first trunnion in the first displacement direction with respect to the first cross beam and rotation of the drive screw in a second direction of rotation results in displacement of the first trunnion in the second displacement direction with respect to the first cross beam.

4. The jack of claim 3 further comprising a first electric motor connected to the first drive screw.

5. The jack of claim 3 further comprising a first crank connected to the first drive screw.

6. The jack of claim 2 wherein the first drive mechanism comprises a first hydraulic or pneumatic actuator connected to the first trunnion.

7. The jack of claim 1 wherein the first leg is pivotally connected to the first brace at a first pivot point proximate an end of the first leg and an end of the first brace.

8. The jack of claim 7 wherein the first pivot point moves predominantly perpendicular to the first cross beam when the first trunnion moves from the first position toward the second position.

9. The jack of claim 7 wherein the first pivot point moves predominantly perpendicular to the first cross beam when the first trunnion approaches and departs the first position.

10. The jack of claim 1 wherein at least two of the first cross beam, the first leg, and the first brace are substantially parallel to each other when the first trunnion is in the second position.

11. The jack of claim 1 further comprising a first foot pivotally connected to the first leg.

12. The jack of claim 1 further comprising:
an intermediate member connected to the first lifting section; and
a second lifting section connected to the intermediate member, the second lifting section comprising:
a second cross beam;
a second trunnion engaged with the second cross beam and selectively displaceable in third and fourth displacement directions with respect to the second cross beam between a third position and a fourth position;
a second leg pivotally connected to the second trunnion; and
a second brace pivotally connected to the second leg and pivotally connected to the second cross beam;
wherein displacement of the second trunnion with respect to the second cross beam in the third displacement direction results in rotation of the second leg in a third angular direction with respect to the second cross beam and rotation of the second brace in the third angular direction with respect to the second cross beam, and
wherein displacement of the second trunnion with respect to the second cross beam in the fourth displacement direction results in rotation of the second leg in a fourth angular direction with respect to the second cross beam and rotation of the second brace in the fourth angular direction with respect to the second cross beam.

13. The jack of claim 12 wherein at least one of the first lifting section and the second lifting section is connectable to the intermediate member in a first configuration with respect to the intermediate member and in a second configuration with respect to the intermediate member.

14. The jack of claim 12 wherein the first trunnion is displaceable independent of the second trunnion and the second trunnion is displaceable independent of the first trunnion.

15. The jack of claim 12 wherein the second leg is pivotally connected to the second brace at a second pivot point proximate an end of the second leg and an end of the second brace.

16. The jack of claim 15 wherein the second pivot point moves predominantly perpendicular to the second cross beam when the second trunnion moves from the third position toward the fourth position.

17. The jack of claim 1 further comprising:
a first mounting plate attached to the first cross beam, the first mounting plate defining a first plurality of apertures arranged in a non-linear configuration.

18. The jack of claim 17 in combination with a first bracket defining a second plurality of apertures and a plurality of fasteners extending through ones of said first plurality of apertures and corresponding ones of said second plurality of apertures.

19. A jack system comprising first and second lifting units,
the first lifting unit comprising:
a first cross beam;
a first trunnion engaged with the first cross beam and selectively displaceable in first and second displacement directions with respect to the first cross beam between a first position and a second position;
a first leg pivotally connected to the first trunnion; and
a first brace pivotally connected to the first leg and pivotally connected to the first cross beam;
wherein displacement of the first trunnion with respect to the first cross beam in the first displacement direction results in rotation of the first leg in a first angular direction with respect to the first cross beam and rotation of the first brace in the first angular direction with respect to the first cross beam, and
wherein displacement of the first trunnion with respect to the first cross beam in the second displacement direction results in rotation of the first leg in a second angular direction with respect to the first cross beam and rotation of the first brace in the second angular direction with respect to the first cross beam; and
the second lifting unit comprising:
a second cross beam;
a second trunnion engaged with the second cross beam and selectively displaceable in third and fourth displacement directions with respect to the second cross beam between a third position and a fourth position;
a second leg pivotally connected to the second trunnion; and
a second brace pivotally connected to the second leg and pivotally connected to the second cross beam;
wherein displacement of the second trunnion with respect to the second cross beam in the third displacement direction results in rotation of the second leg in a third angular direction with respect to the second cross beam and rotation of the second brace in the third angular direction with respect to the second cross beam, and
wherein displacement of the second trunnion with respect to the second cross beam in the fourth displacement direction results in rotation of the second leg in a fourth angular direction with respect to the second cross beam and rotation of the second brace in the fourth angular direction with respect to the second cross beam;
wherein the first trunnion is displaceable independent of the second trunnion and the second trunnion is displaceable independent of the first trunnion.

20. The system of claim 19 wherein:
the first leg is pivotally connected to the first brace at a first pivot point proximate an end of the first leg and an end of the first brace;
the first pivot point moves predominantly perpendicular to the first cross beam when the first trunnion moves from the first position toward the second position;
the second leg is pivotally connected to the second brace at a second pivot point proximate an end of the second leg and an end of the second brace; and
the second pivot point moves predominantly perpendicular to the second cross beam when the second trunnion moves from the third position toward the fourth position.

21. The system of claim 19 wherein the first and second displacement directions are not parallel to the third and fourth displacement directions.
